(19) United States
(12) Patent Application Publication
(10) Pub. No.: US 2008/0266119 A1
(43) Pub. Date: Oct. 30, 2008

(54) Ultimate improvement in high way safety

(76) Inventor: Kallis Hans Mannik, Thomaston, GA (US)

Correspondence Address: KALLIS HANS MANNIK, P.O. BOX 467, THOMASTON, GA, 30286, US

(21) Appl. No.: 11/796,762

(22) Filed: Apr. 30, 2007

(51) Int. Cl. G08B 23/00

(52) U.S. Cl. 340/575

(57) ABSTRACT

This invention is for somebody, who has fallen asleep, while driving a car, and wants it never to happen again.

This invention is for family father, who has to drive to work every day and who wants to be sure, that breadwinner arrives every night from work, this is for taxi drivers, pizza delivery men, UPS truck drivers, school bus drivers and whose income depends on safe driving. This invention is needed also for trucking co's who want their customers goods to arrive without car accidents, caused by drivers falling asleep while driving a truck.

This invention is eyeglasses attachable optosensor, which detects, when the drivers eyes are closed or open, and after eyes are closed over half of a second starts a wake up buzzer signal. In case the driver doesn't wake up after 3-5 seconds, the Freeway Blaster truck horn's sound will definitely wake up the sleepy driver.

It is expected that this invention receives such a positive general acceptance, that a driver wake up device according to this invention, will be built into every new car as a standard equipment, in every country throughout the world.

### BRIEF SUMMARY OF THE INVENTION

Years ago it was introduced in automobiles automatic transmission instead of manual shift, during several years were introduced anti skid brakes, incremental windshield wipers, cruise control, seat-belts and air-bags. My present invention, will be a valuable addition to these past turning point improvements of the highway traffic.

Give to the world a better mouse trap and the world will beat a path to it.

I feel that way towards my present invention, a perfect device to wake up an automobile driver, who is in grave danger of falling asleep, while driving his or her automobile.

About six months ago I counted how many of my family members and good close friends had had car accidents, including 3 death and 2 totaling of cars caused by car drivers falling asleep. The total was 15 car accidents, caused by car drivers, who were falling asleep, while driving a car. The deadliest accident was collision between my friends car and a car driven by four young tourists returning from a sleepless night in Grand Canyon because they didn't find a hotel or motel and were staying in their car overnight.
I myself did fall asleep during a snowy winter night on Queen Elisabeth Highway in Canada. I was awakened by bright light reflecting the light from my car headlights from a snow bank on the side of the road. I had been dreaming, that I was in a church and that the bright lights of the church were around me, and lights of the church were shining on me.

But after being recently in a car, where the driver, who had no record of ever falling asleep while driving, suddenly fell asleep at 75 MPH speed on Highway I-75, I sat down and designed the ultimate car driver wake up device with a safety margin 400% better than previous arts similar automobile drivers wake up devices and with a wake up signals sequence which positively will wake up any automobile driver who uses this device.

In case this device will be incorporated in all new cars and a large number of cars, already on roads, the highway safety will increase considerably.

### BACKGROUND OF THE INVENTION

Several inventions for sleep prevention, while driving, are based on sensing the position of the upper eyelid of the driver, usually by means of checking whether it is on the way of an infrared light beam or not. This kind of driver wake up devices are very much depending on that the eyeglasses distance from the eye surface stays constant. Usually eyeglasses position movement exceeding one millimeter will cause this device to generate erroneous signal. A minor eyeglass position change would give to the driver a false alarm signal, or still worse, it can cause missing of an alarm signal, in case the driver has fallen asleep and closed his eyes.

The device according to the present invention has a tolerance in eyeglasses moving relative to the position of the eyes at least five millimeters (one millimeter eyelid thickness plus 4 millimeters of a little flag, mounted on the upper eyelid). Thus the tolerance for eyeglasses movement relative to the position of eyes is increased 400% as compared to similar previous driver wake up devices.

An additional advantage of the current invention is, that it doesn't give any wrong signals caused by eye wetting blinks. That it gives an alarm after the eyes of the driver have been closed for more than a half of a second and that it gives a very loud signal with Freeway Blaster car horn after driver's eyes have been closed longer time than 3 to 5 seconds. Drivers who don't like the laud Freeway Plaster sound, can install in their cars as the second alarm source a loud siren sound.

### BRIEF DESCRIPTION OF THE SEVERAL VIEWS OF THE DRAWINGS

On the FIG. 1 it is shown how a tiny flag 1 FIG. 1 is attached to the upper eyelid 2, FIG. 1 of a car driver with a strip of a double adhesive tape, 3, FIG. 1,

In FIG. 2, FIG. 3, FIG. 4 and FIG. 5 it is shown different types of The upper eyelid's flag.

This flag can be made of a strip of a double adhesive tape 3, FIG. 2 on which it is attached a piece of a flexible material 4, FIG. 2, folded into a little flag 1, as shown in FIG. 2.

This flag can be also made of a band aid strip 5, FIG. 3, on which it is glued a flexible flag 1, FIG. 3, as shown in FIG. 3, made for example of soft rubber with dimensions 3 mm×4 mm×0.2 mm. This flag can be made also of a band aid strip, which is folded into a tiny flag and its adhesive side attached to the upper eyelid of a car driver, as shown in FIG. 4.

A flag, made of silver colored foil, which is attached with a double sticky tape to the upper eyelid of the car drive, is shown on FIG. 5.

This silver colored flag is used for the alternate solution of this invention, shown in FIG. 6, where two tiny mirrors are mounted on one of the eyeglasses, shown in FIG. 6, with about 4 mm distance between them.

In FIGS. 7, 8 and 9 are shown three different upper eyelids with attached tiny flags, according to the present invention,

FIG. 10 shows how the infrared light beam 7 FIG. 10 passes the eye surface when the drivers eyes are open, without starting the alarm sequence.

FIG. 11 shows how the infrared light beam will be reflected by the tiny flag when the drivers eyes are closed, thus initiating the driver wakeup device electrical sequence

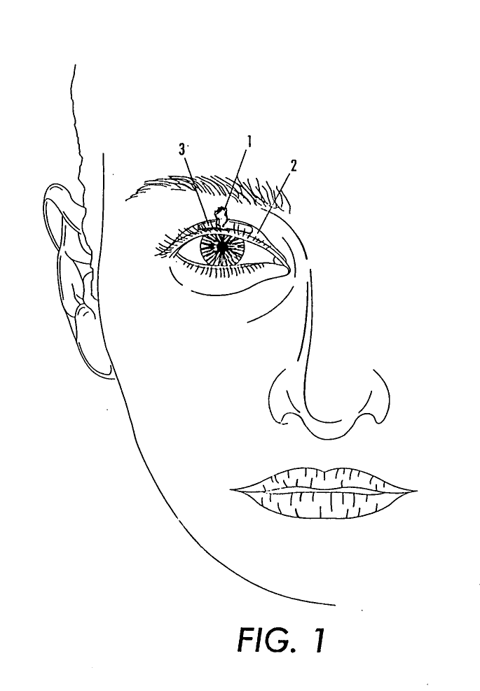

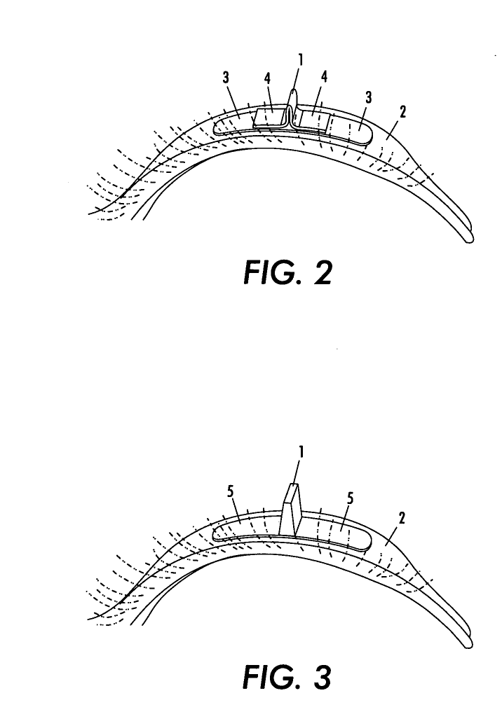

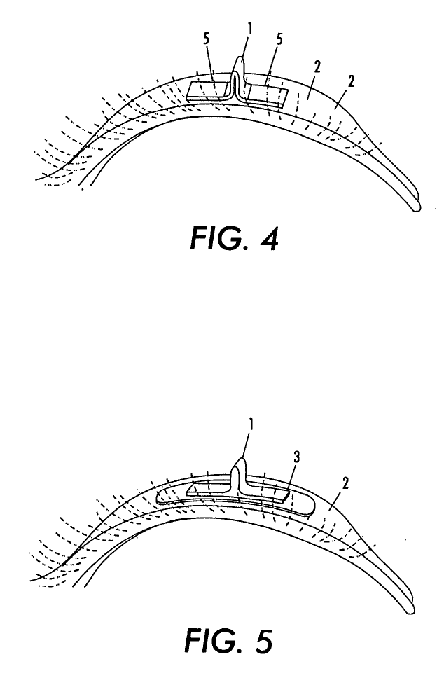

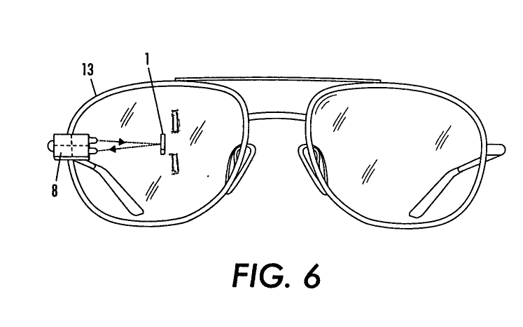

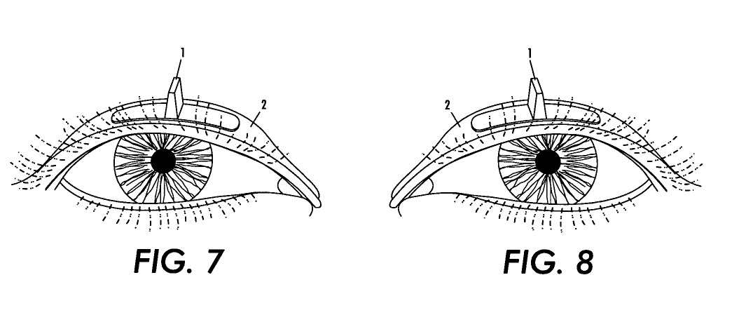

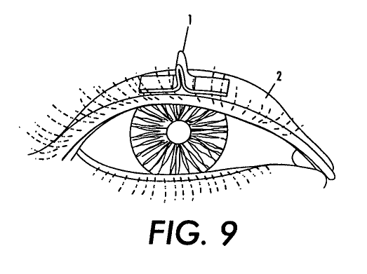

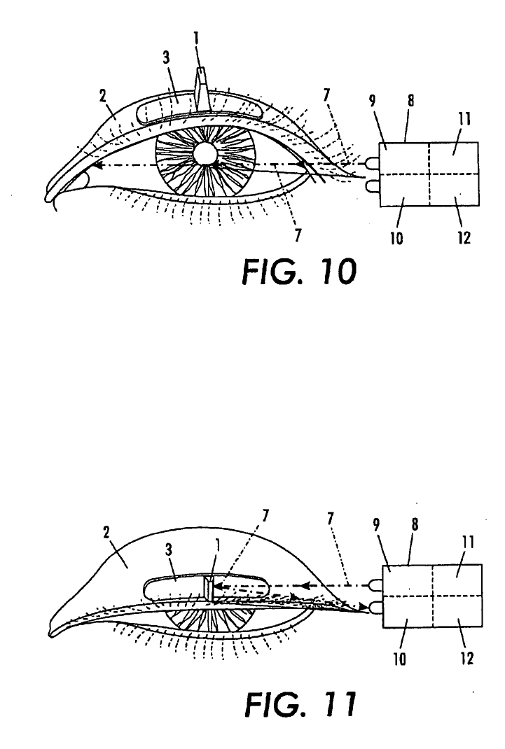

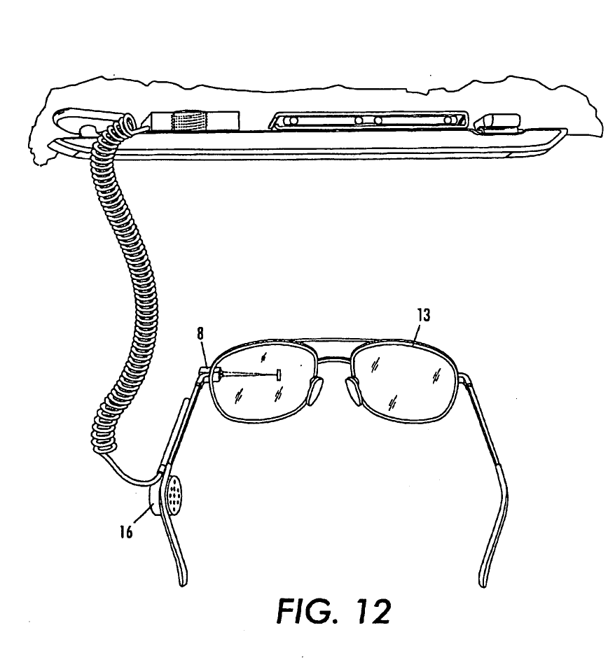

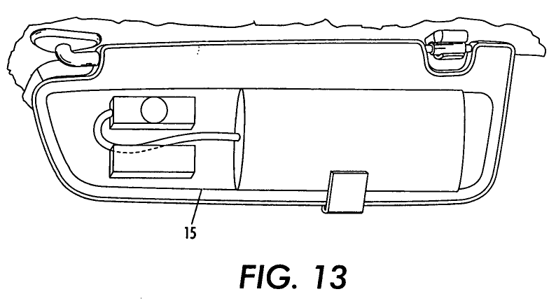

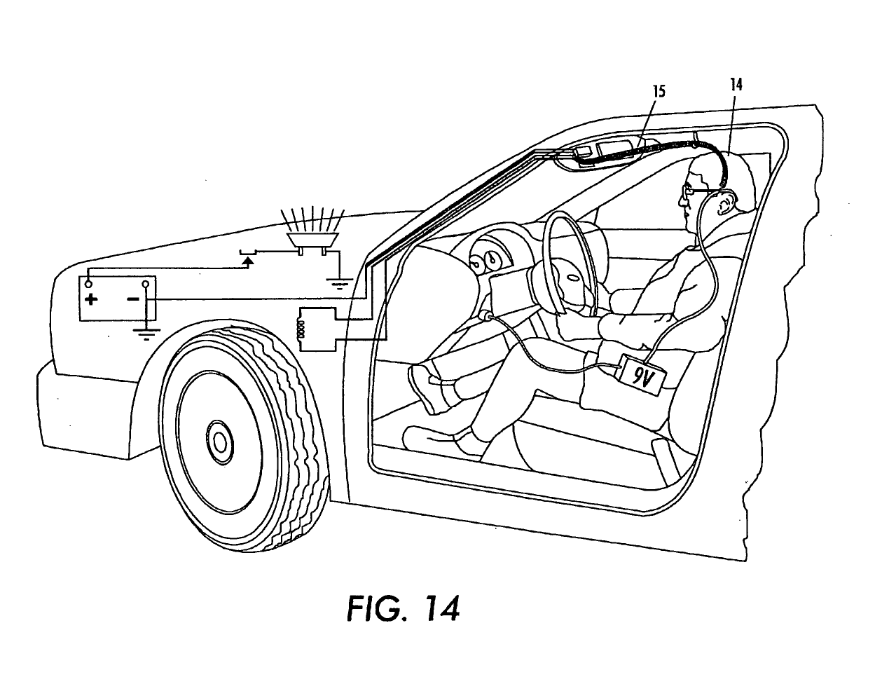

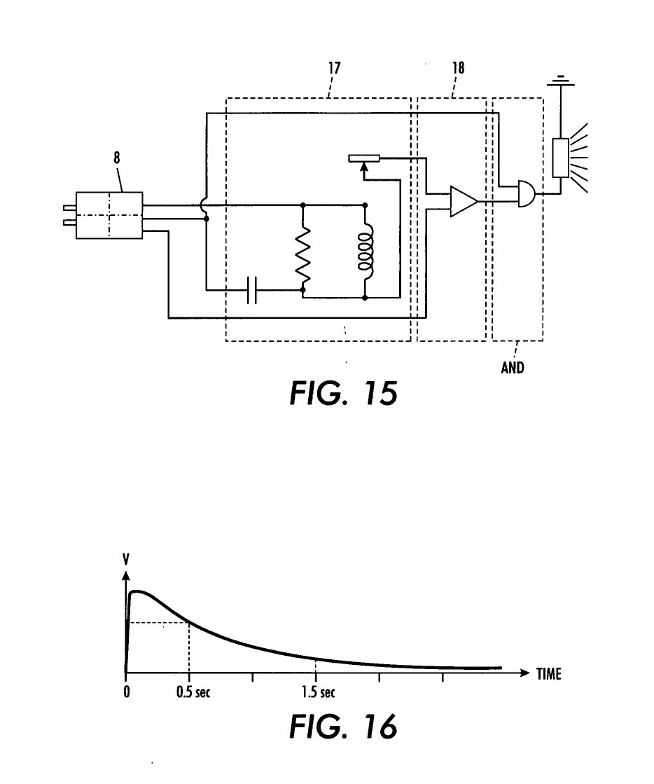

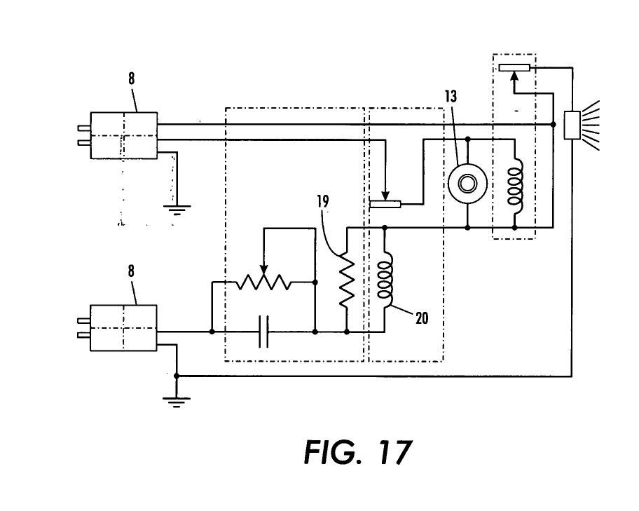

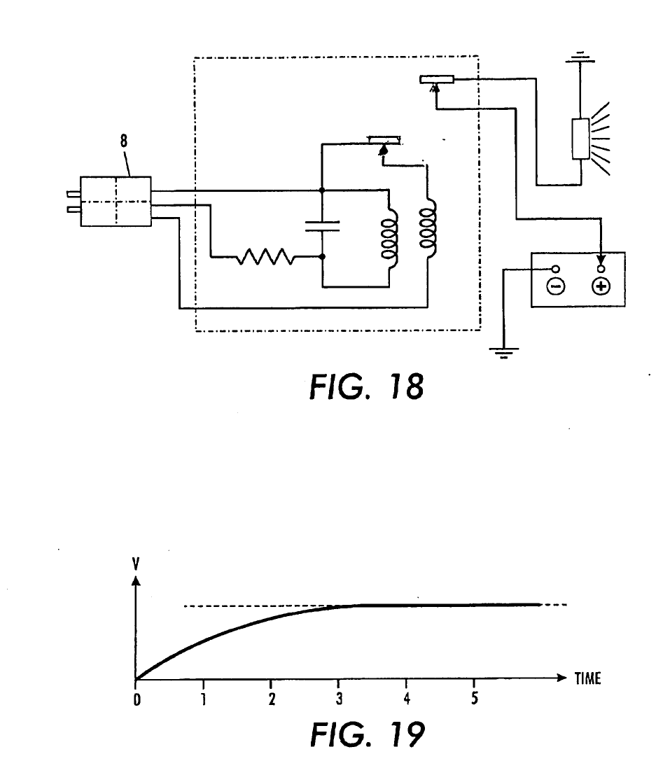

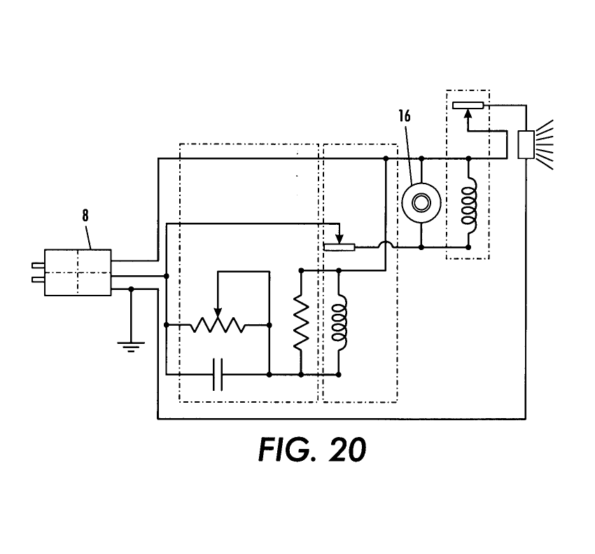

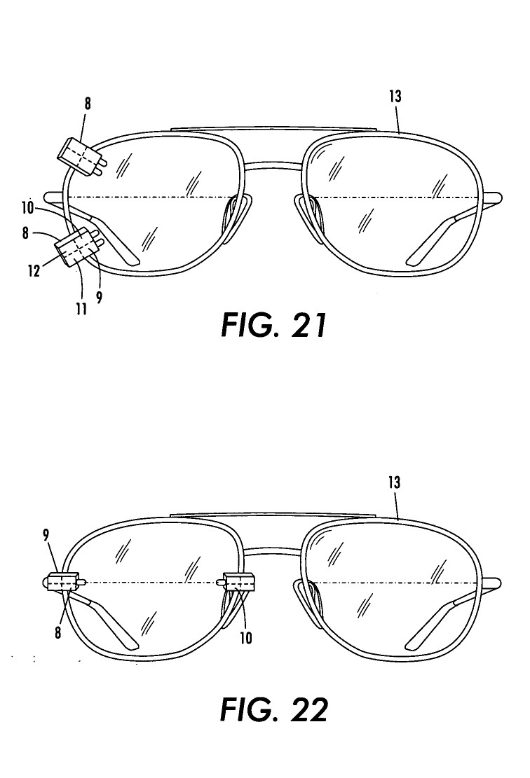

On the FIG. 10 and FIG. 11 it is also shown graphically two optosensors 8 FIG. 10 and FIG. 11. A optosensor 8 consists of a pulse modulated light emitter 9 FIG. 10, of a pulse modulated infrared light detector 10, FIG. 10, of an amplifier 11 FIG. 10 for the infrared light emitter and of an amplifier 12, FIG. 10 for the infrared light detector.

In the FIG. 12 it is shown, how the driver wake up eyeglasses 13 FIG. 12 are connected with a spiral-coiled cable 14 FIG. 12 on the sun visor 15 of the car driver. On FIG. 12 it is also shown how the wake up signal buzzer 16 FIG. 12, is mounted on the eyeglasses.

In FIG. 13 it is shown how the eyeglasses are stored on the sun visor 17 when not in use. On the sun visor it is also placed a little container to store a number of upper eyelid's flags for future car rides. On the sun visor it is also placed the necessary electronic components for operating the automobile driver wake up device.

In FIG. 14 it is shown how the driver wake up eyeglasses are hanging from the ceiling above the drivers head, for easy usage, when needed. The spiral coiled wire helps to lift slightly the eyeglasses. Having this spiral coiled wire lifting slightly the eyeglasses, the wearer feels as if the eyeglasses were lighter, than they rally are.

In FIG. 14 it is also shown how the wiring of this device is done in case this driver wake up device is incorporated into the car already during the manufacturing.

The spiral-coiled cable is connecting the eyeglasses with the sun visor. From sun visor are the wires connecting the driver wake up device with the cigarette lighter as voltage source or with the car battery. In FIG. 14 it is also shown the Freeway Blaster Horn circuitry, which is located under the car hood.

In case the driver is carrying the driver wake up device himself, the wires are connecting a 9-Volts battery in his pocket with wires from the eyeglasses. From the pocket is with a flexible cable the driver wake up device connected with the cigarette lighter output of the car, in order to get power from the car battery. With the wires in this flexible cable, is also the Freeway Blaster Horn connected to the driver wake up circuitry.

In FIG. 15, FIG. 17, FIG. 18 and FIG. 20 are shown circuits for generating the alarm signals.

The timing diagram in FIG. 16 shows graphically how after 0.5 seconds of the divers falling asleep, the audio alarm signal is generated.

The timing diagram in FIG. 19 is showing how the Freeway Blaster Horn's signal is generated.

As shown in FIG. 6 and in FIG. 12, the optosensor and its infrared emitter and detector can be mounted usually horizontally on the eyeglasses frame.

Nevertheless, optosensor and its infrared light emitting emitter, and its infrared light detecting detector, can be mounted on the eyeglasses frame under an angle, for ex 45 degrees above the horizontal line or 45 degrees below the horizontal line as shown in FIG. 21.

Advantage with placing the optosensor above or below the horizontal line is that in this way the left and right side vision fields for driver remain completely obstructions free, free from optical and electronical components.

### DETAILED DESCRIPTION OF THE INVENTION

The primary objective of this invention is to provide millions of car drivers with a very reliable, simple eyeglass attached sleep prevention device, which definitely wakes up a sleepy driver with two step wake up signals after 3 to 5 seconds after he closed his eyes, with Freeway Plaster truck horn sound, in case this car driver has slept through the first buzzer sound.

Tens of millions car drivers around the world will probably need this kind of a novel safety device, to prevent possible deadly accidents.

This invention is an eyeglasses attachable pulse modulated infrared emitter/detector device, which alter detecting, that the driver is falling asleep, generates first an audible buzzer signal, followed 3-5 seconds later by the sound of Freeway Plaster horn signal, in case the automobile driver has not waken up while hearing the buzzer sound. An infrared light emitter is arranged to send out a beam of light between the upper and the lower eyelids of the driver, and between the surface of his eye and between the inner surface of his eyeglasses glass

According to this invention, in the middle of the driver's upper eyelid it is attached a tiny, vertical, round, square or rectangular piece of a thin flexible material, formed like a flag, as shown in FIGS. 1, 2 3 and 4. The preferred size of this tiny flag is about 3×4 millimeters. But any other size of a flag can be used

When the driver is awake, and his eyes are open, the beam of the infrared light will not be reflected, thus no wake up alarm will go off.

In case the eyes of the driver are closed, then his upper eyelid and the flag on his upper eyelid are reflecting the infrared light beam from the emitter to the detector, which activates the wake up audio signal, the buzzer.

Another mode of this invention is eyeglasses provided with two tiny mirrors, size about 4×4 millimeters, mounted next to the nosepiece of the eyeglasses with about 4 millimeters distance from each other, as shown in FIG. 6. Using this mode of the present invention, on the upper eyelid mounted flag has to be made of light reflecting, silver colored material. It is shown in FIG. 5, how the flag could be made of silver colored foil for this mode of this invention. A double sticky tape can have this folded silver colored flag attached on its top surface. The lower side of the double adhesive tape will be attached to the upper eyelid of one of the eyes of the car driver.

When the driver is awake, the infrared light beam goes between the two tiny mirrors and gets scattered, after passing these mirrors. In case the drivers eyes are closed, this little silver colored flag will be positioned between the two tiny mirrors on the eyeglass and the infrared light beam will be reflected back to the infrared detector and will set up the driver wake up signals audio signal, buzzer and subsequently the Highway Blaster horn signal, in case the driver has not been awakened with the buzzer signal.

When this device according to this invention goes into mass production it will be advantageous to remodel in some degree the eyeglasses already at eyeglasses frames factory, by means of mowing up the eyeglass nose pads 1-3 millimeters. In this way it is possible to use a flag of size 4×5 millimeters, instead of a 4×4 size flag. This change will make the wake up device less sensitive to any eyeglass movement during driving.

For automobile driver, who wears no eye glasses, because his or her distance vision is good enough for automobile driving, or for automobile drivers, who use contact lenses, it can be used eyeglass frames without lenses, for mounting onto it the infrared light emitter, detector and audio alarm buzzer.

The normal eye wetting pulses could generate unwanted short audio signals, while the driver is using this wake up device while driving. These pulses can be eliminated by means of a circuitry, shown in FIG. 5

The driver/s eye wetting blinks generate short electric pulses.

The electric short eye wetting pulse, coming in from the detector is first differentiated in the differentiating circuitry 17 FIG. 15 The signal form after differentiation is shown in FIG. 16. The resulting signal is in an inverter circuitry 18 FIG. 15 changed into a negative pulse. This and the original signal from the detector are combined in a AND circuitry, which eliminates the eye wetting pulse and lets go through the closed eye pulse, in case the eye is closed longer than a half of a second, as shown in FIG. 16.

Alternately the eye wetting pulse, coming from the infrared detector is differentiated in the differentiating circuitry, where parallel to the resistor 19 FIG. 17 it is connected a relay 20 FIG. 17 The NC (normally closed) contact on this relay is arranged to disconnect the eye wetting pulse signal to the buzzer. When this relays voltage drops, as shown in FIG. 16, it will no more eliminate incoming pulses from detector;

In case the automobile driver is too tired, or too sleepy and doesn't wake up on the audio alarm signal from the buzzer, a very loud wake up signal is generated by means of a circuitry described in the following:

When the driver's eyes are closed, the reflected light from the flag generates an electric signal in the detector circuitry. This signal will be integrated in circuitry, shown in FIG. 18 consisting of a resistor and a capacitor Slowly the integrated signal output between the resistor and capacitor is increasing and after 3 to 5 seconds it will activate a relay as shown in FIG. 13 This relay activates the horn relay which is mounted under the hood of the automobile. The relay under the hood connects the car battery with the contacts of the Freeway Plaster car horn, to generate a really loud driver wake up signal.

FIG. 14 shows how this invention is incorporated into the automobile already at manufacturing. The eyeglasses with infrared light emitter and infrared light detector are connected with electronic circuitry the sun visor by means of a spiral coiled wire as shown in FIG. 12. The eyeglasses are hanging on this spiral coiled wire on a hook in the car ceiling, so that driver can conveniently put these eyeglasses on while driving. When he is not using these, driver wake-up device eyeglasses will be stored in a case, shown in FIG. 12 attached to the sun visor. As shown in FIG. 1o from sun visor are wires going to either cigarette lighter or are directly connected with the car battery, to power the equipment

In case this driver wake up device is not yet incorporated into the car at the manufacturing, the car driver can use this driver wake up device while it is connected to a 9 Volts battery in his pocket for powering this device or by means of using a flexible cable from the eyeglasses to the cigarette lighter, to power this device.

The wiring of the wake up device from the optosensor on the eyeglasses to the cigarette lighter and from cigarette lighter to the Freeway Blaster horn's relay under the hud, is shown in FIG. 14.

It is expected that this invention receives such a positive general acceptance, that a driver wake up device according to this invention, will be built into every new car as a standard equipment, in every country throughout the world.

This invention has considerably improved stability as compared to prior arts similar eyeglasses attachable driver wake up devices This invention is in essence:

An eyeglasses attachable driver wakeup device with emitting means for generating pulse modulated infrared light beam and with receiving detector means for receiving said emitter generated beams where the emitting means are sending at least one beam across the eye just above the eyeball surface but below the inside surface of the eyeglasses, arranged to work in unison with a tiny flag, attached to the upper eyelid of the car driver. Comprising:
(1) Light emitter for emitting a narrow beam of pulse modulated infrared light.
Adjustable mounting means for mounting said emitter on the temple or frame of said eyeglasses, in such away, that the pulsating light beam traverses one of the driver's eyes just above the surface of the eye, below the inside surface of the eyeglasses and between the upper and lower eyelids. while the driver's eyes are open.
(2) Light detector means, receiving a large amount of the emitted infrared light, reflected by the upper eyelid's flag when the drivers eyes are closed, and receiving only random scattered light when the drivers eyes are open, for out putting electrical signals, characteristic to the received pulsating light beam and characteristic to the ambient scattered light.
(3) In order to stabilize this automobile driver wake up device and to make it insensitive to any minor eyeglass movement during driving of a car, the automobile driver will attach with tape on his or on her upper eyelid a tiny flag, chad or tab.
(4) This flag or tab placed on drivers upper eyelid, can be square, round or rectangular, and it can be made with various colors, and of various materials with various softness, without changing the invention's main idea, which is an about 400% increase in the target area for the sensing beam of the emitted, pulse modulated infrared light beam, as compared to the prior art similar on the eye and eyelid movement based techniques.
(5) This flag which can be made of regular medical band aid. Regular band aid is tested out during many years for usage on various parts of human body, thus the use of a narrow strip of a band aid as carrier of a tiny 4×4 mm flag, would be no different to the band aid use on any other part of the human body
(6) This flag can be made also by using thin soft double adhesive foam on which can be glued a tiny flag, for. ex. made of rubber, or some other soft, flexible material.
(7) This flag which can be made of (thin) double adhesive
(8) a foam tape strip, on which is attached a strip of a folded thin silvery foil, this foil being folded into a tiny about 3×4 mm flag.
(9) comprising many unusual forms and shapes automobile drivers can design their flags
(10) A flag directly from fantasyland is made of a super thin well sealed rubber. When the driver's eyes are open, this flag is nicely folded between his upper eyelid and between his eyebrow. When his eyes close, this tiny balloon pops into a 4×4 millimeter flag which will unfold between the upper eyelid and the eyeglasses inre surface.
(11) Electronic alarm signal generating circuitry for receiving said electrical signals of said pulsating infrared light, detecting input light variations and converting said light input variations into alarm signals when drivers eyes are closed,
(12) To generate a signal, with an alarm “buzzer” starting after an ½ of a second and with eyewetting signals eliminated, a circuitry will be used with an input differential circuitry. Output of this circuitry will be reversed in the next step amplifier. The output of that next amplifier will be combined with the output of the optosensor in an AND circuitry. The output of the AND circuitry will have all the disturbing eyewetting pulse signals eliminated and it starts a buzzer signal ½ of a second after the driver has closed his or her eyes.
(13) A second step alarm signal generator, the Freeway Blaster car horn will be turned on in case the driver has not e opened his eyes. during 3-5 seconds while the buzzer sound has been on
(11) To generate a signal which starts a Freeway Blaster horn in 3-5 seconds, a circuitry is used with an integrating circuitry input which activates a reed relay after the voltage across the integrating circuits capacitance has increased to the reed relay triggering level.

An automobile driver wake up device, according to the claim 1, wherein that power source is consisting of 1) a 9 Volts battery, connected with short leads from a pocket of the driver to the driver wake-up device eyeglasses, 2) of a power plug with a light weight cable between the drivers pocket and the cigarette lighter outlet, connecting the driver wake up device electronics to the car battery as the voltage source.

An automobile driver wake up device, according to the claim 1, where the wiring is done during the car being on production line. Thus the mounting of the Freeway Blaster under the car hood can be done in most proper position, the wires from the car battery to the driver wake up device electronics on the driver side sun visor can be discreetly placed inside of the paneling and the driver wake up eyeglasses can be placed esthetically pleasant position close to the driver of the car.

What is claimed is:

1. An eyeglasses attachable driver wakeup device with emitting means for generating pulse modulated infrared light beam and with receiving detector means for receiving said emitter generated beams where the emitting means are sending at least one beam across the eye just above the eyeball surface but below the inside surface of the eyeglasses, arranged to work in unison with a tiny flag, attached to the upper eyelid of the car driver.
Comprising:
(1) Light emitter for emitting a narrow beam of pulse modulated infrared light.
Adjustable mounting means for mounting said emitter on the temple or frame of said eyeglasses, in such away, that the pulsating light beam traverses one of the driver's eyes just above the surface of the eye, below the inside surface of the eyeglasses and between the upper and lower eyelids. while the driver's eyes are open.
(2) Light detector means, receiving a large amount of the emitted infrared light, reflected by the upper eyelid's flag when the drivers eyes are closed, and receiving only random scattered light when the drivers eyes are open, for out putting electrical signals, characteristic to the received pulsating light beam and characteristic to the ambient scattered light.
(3) In order to stabilize this automobile driver wake up device and to make it insensitive to any minor eyeglass movement during driving of a car, the automobile driver will attach with tape on his or on her upper eyelid a tiny flag, chad or tab.
(4) This flag or tab placed on drivers upper eyelid, can be square, round or rectangular, and it can be made with various colors, and of various materials with various softness, without changing the invention's main idea, which is an about 400% increase in the target area for the sensing beam of the emitted, pulse modulated infrared light beam, as compared to the prior art similar on the eye and eyelid movement based techniques.
(5) This flag which can be made of regular medical band aid. Regular band aid is tested out during many years for usage on various parts of human body, thus the use of a narrow strip of a band aid as carrier of a tiny 4×4 mm flag, would be no different to the band aid use on any other part of the human body
(6) This flag can be made also by using thin soft double adhesive foam on which can be glued a tiny flag, for. ex. made of rubber, or some other soft, flexible material.
(7) This flag which can be made of (thin) double adhesive
(8) a foam tape strip, on which is attached a strip of a folded thin silvery foil, this foil being folded into a tiny about 3×4 mm flag.
(9) comprising many unusual forms and shapes automobile drivers can design their flags
(10) A flag directly from fantasyland is made of a super thin well sealed rubber. When the driver's eyes are open, this flag is nicely folded between his upper eyelid and between his eyebrow. When his eyes close, this tiny balloon pops into a 4×4 millimeter flag which will unfold between the upper eyelid and the eyeglasses inre surface.
(11) Electronic alarm signal generating circuitry for receiving said electrical signals of said pulsating infrared light, detecting input light variations and converting said light input variations into alarm signals when drivers eyes are closed,
(12) To generate a signal, with an alarm “buzzer” starting after an ½ of a second and with eyewetting signals eliminated, a circuitry will be used with an input differential circuitry. Output of this circuitry will be reversed in the next step amplifier. The output of that next amplifier will be combined with the output of the optosensor in an AND circuitry. The output of the AND circuitry will have all the disturbing eyewetting pulse signals eliminated and it starts a buzzer signal ½ of a second after the driver has closed his or her eyes.
(13) A second step alarm signal generator, the Freeway Blaster car horn will be turned on in case the driver has not e opened his eyes. during 3-5 seconds while the buzzer sound has been on
(11) To generate a signal which starts a Freeway Blaster horn in 3-5 seconds, a circuitry is used with an integrating circuitry input which activates a reed relay after the voltage across the integrating circuits capacitance has increased to the reed relay triggering level.
An automobile driver wake up device, according to the claim 1, wherein that power source is consisting of 1) a 9 Volts battery, connected with short leads from a pocket of the driver to the driver wake-up device eyeglasses, 2) of a power plug with a light weight cable between the drivers pocket and the cigarette lighter outlet, connecting the driver wake up device electronics to the car battery as the voltage source.
An automobile driver wake up device, according to the claim 1, where the wiring is done during the car being on production line. Thus the mounting of the Freeway Blaster tinder the car hood can be done in most proper position, the wires from the car battery to the driver wake tip device electronics on the driver side sun visor can be discreetly placed inside of the paneling and the driver wake up eyeglasses can be placed esthetically pleasant position close to the driver of the car

2. An eyeglass attachable driver wake up device
Comprising:
(1) Another mode of this invention. Eyeglasses provided with two tiny mirrors, size about 4×4 millimeters, mounted next to the nosepiece of the eyeglasses with about 4 millimeters distance from each other,
Using this mode of the present invention, on the upper eyelid mounted flag has to be made of light reflecting, silver colored material. It is shown in FIG. 5, how the flag could be made of silver colored foil for this mode of this invention. A double sticky tape can have this folded silver, colored flag attached on its top surface. The lower side of the double adhesive tape will be attached to the upper eyelid of one of the eyes of the car driver.
When the driver is awake, the infrared light beam goes between the two tiny mirrors and gets scattered, after passing these mirrors. In case the drivers eyes are closed, this little silver colored flag will be positioned between the two tiny mirrors on the eyeglass and the infrared light beam will be reflected back to the infrared detector and will set up the driver wake up signals audio signal, buzzer and subsequently the Highway Blaster horn signal, in case the driver has not been awakened with the buzzer signal.
